(19) United States
(12) Patent Application Publication
(10) Pub. No.: US 2009/0265076 A1
(43) Pub. Date: Oct. 22, 2009

(54) CONTROL DEVICE FOR INTERNAL COMBUSTION ENGINE

(75) Inventor: Masayoshi HIROSE, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRONIC CORPORATION, Tokyo (JP)

(21) Appl. No.: 12/258,917

(22) Filed: Oct. 27, 2008

(30) Foreign Application Priority Data
Apr. 18, 2008 (JP) 2008-108818

(51) Int. Cl. F02D 41/00

(52) U.S. Cl. 701/103

(57) ABSTRACT

To improve accuracy of learning of a full-close reference position of a throttle valve while suppressing deterioration in startability and mechanical durability and power consumption, an ECU performs position learning processing and learning permission judgment processing as a part of opening and closing control for the throttle valve. In the learning permission judgment processing, the ECU judges whether all of a first learning permission condition, a second learning permission condition, and a third learning permission condition are satisfied. The third learning permission condition is a condition judged by the ECU as being satisfied when intake passage pressure MP exceeds a predetermined value kMP registered in the ECU in advance. The predetermined value kMP is a value for excluding an error due to negative pressure from throttle opening TP detected by a throttle opening sensor.

### BACKGROUND OF THE INVENTION

1. Field of the Invention

The present invention relates to a control device for an internal combustion engine that has a function of an electronic throttle system for driving an actuator according to an accelerator operation amount or the like and controlling throttle opening of a throttle valve.

2. Description of the Related Art

In a general internal combustion engine, the opening of a throttle valve forming a part of an electronic throttle is monitored by an electronic control unit (ECU) via a throttle opening sensor. Opening and closing of the electronic throttle is controlled by this ECU.

The throttle opening sensor outputs the opening of the throttle valve as a voltage value (electric resistance value). Even when the mechanical opening of the throttle valve is constant, respective voltage values of the throttle opening sensor may fluctuate because of respective manufacturing errors of the throttle opening sensor. Voltage values output from the throttle opening sensor may also fluctuate because of aged deterioration of the throttle opening sensor. Therefore, the ECU needs to execute position learning processing and learn (capture) a full-close reference position and a full-open reference position on the basis of respective voltage values of the throttle opening sensor in a full-close position (full-close state) and a full-open position (full-open state) of the throttle valve.

Specifically, in the position learning processing for the full-close reference position of the throttle valve, first, a valve lever connected to a shaft pivoted together with the throttle valve is pressed against a full-close stopper (striking control is performed). The ECU learns (stores) the full-close reference position of the throttle valve on the basis of a voltage value of the throttle opening sensor at this point. In the position learning processing for the full-open reference position of the throttle valve, the valve lever is pressed against a full-open stopper. The ECU learns the full-open reference position of the throttle valve on the basis of a voltage value of the throttle opening sensor at this point.

For example, with regard to the position learning processing as described above, in a conventional throttle control device for an internal combustion engine disclosed in JP 2003-138971 A, the position learning processing for the throttle valve is executed by an ECU when a learning start condition (judgment permission condition) such as a temperature difference in cooling water temperature from that in the previous learning or elapsed time from the previous learning is satisfied.

In a conventional internal combustion engine disclosed in JP 2000-120450A, when the engine is stopped, a throttle valve is arranged in a full-close position by an ECU. When the engine is started, before cranking is started, i.e., before negative pressure is generated in an intake passage following the cranking, position learning processing for the throttle valve is executed by the ECU.

Moreover, in a conventional throttle valve device for an internal combustion engine disclosed in JP 11-159352 A, when the engine is stopped, in order to prevent noise from being generated from an intake passage having a strong negative pressure, a throttle valve is held at predetermined opening for a predetermined time. After the predetermined time elapses, position learning processing for the throttle valve is executed by the ECU.

In the general internal combustion engine, immediately after the engine is stopped, intake passage pressure is lower on a downstream side (internal combustion engine side) than on an upstream side (air intake port side) of the throttle valve and negative pressure is generated in the intake passage. In particular, when the throttle valve is arranged in the full-close position as in an idling state of the internal combustion engine, the negative pressure is relatively large. When the throttle valve is arranged in the full-close position, the negative pressure is not immediately eliminated but is eliminated as time elapses.

In a case where the ECU executes the position learning processing for the throttle valve while the negative pressure is generated, when the throttle valve is forced to be arranged in the full-close position defined by the full-open stopper, the throttle valve is affected by the negative pressure and pressed further in a closing direction with respect to an actual full-close position. In the throttle valve arranged in the full-close position, an error occurs in a voltage value of the throttle opening sensor affected by the negative pressure with respect to a voltage value of the throttle opening sensor not affected by the negative pressure.

In the case where the error occurs in the voltage value of the throttle opening sensor affected by the negative pressure in this way, when the ECU learns the full-close reference position of the throttle valve, the ECU learns the full-close reference position of the throttle value on the basis of a wrong voltage value. In other words, the ECU erroneously learns a full-close position of the throttle valve and an error occurs between the actual full-close position of the throttle valve and the full-close reference position learned by the ECU. As a result, accuracy of control of an intake air amount falls.

In addition, in the conventional throttle control device for the internal combustion engine disclosed in JP 2003-138971 A, negative pressure in the intake passage of the internal combustion engine is not included in the condition for starting the position learning processing for the throttle valve. Therefore, when the negative pressure is relatively large, in the case where the position learning processing for the throttle valve is executed, the ECU erroneously learns the full-open reference position of the throttle valve. As a result, accuracy of learning of the full-close reference position falls.

In the conventional internal combustion engine disclosed in JP 2000-120450 A, the throttle valve is arranged in the full-close position when the engine is stopped and, when the engine is started, the position learning processing for the throttle valve is executed by the ECU. However, in the general internal combustion engine, after the engine is stopped, power supply to an actuator is stopped and the throttle valve is held in an intermediate position for evacuation traveling (traveling for evacuating a vehicle to a roadside belt). Therefore, when the engine is started, for execution of the position learning processing by the ECU, time for displacing the throttle valve from the intermediate position to the full-close position is necessary. As a result, startability of the internal combustion engine is deteriorated and the start of the internal combustion engine is delayed.

Moreover, in the conventional throttle valve device for the internal combustion engine disclosed in JP 11-159352 A, when the ECU learns the full-close reference position of the throttle valve, the ECU excessively drives a motor in order to hold the throttle valve at predetermined opening for a predetermined time regardless of whether negative pressure is generated. Therefore, power consumption increases and mechanical durability is deteriorated.

### SUMMARY OF THE INVENTION

The present invention has been made in order to solve the above-mentioned problems, and an object of the present invention is therefore to provide a control device for an internal combustion engine that can improve accuracy of learning of a full-close reference position of a throttle valve while suppressing deterioration in startability and mechanical durability and power consumption.

According to the present invention, there is provided a control device for an internal combustion engine, including a throttle-valve control unit that monitors throttle opening of a throttle valve which opens and closes an intake passage, accelerator opening, and intake passage pressure, controls opening and closing of the throttle valve according to the accelerator opening by driving an actuator connected to the throttle valve, drives, when it is judged that a predetermined learning start condition is satisfied, the actuator to arrange the throttle valve at a limit in an operation range in a closing direction, and learns a full-close position of the throttle valve as a full-close reference position on the basis of the throttle opening of the throttle valve at the limit, in which the throttle-valve control unit judges, during engine stop, whether the learning start condition is satisfied on the basis of a mutual relation between a predetermined learning start reference value and the intake passage pressure.

With the control device for the internal combustion engine according to the present invention, the throttle-valve control unit judges, on the basis of the mutual relation between the predetermined learning start reference value and the intake passage pressure, whether the learning start condition is satisfied. When it is judged that the learning start condition is satisfied, the throttle-valve control unit performs learning of the full-close reference position of the throttle valve. Therefore, it is possible to perform position learning for the throttle valve in a state where pressing force against the throttle valve due to negative pressure is reduced or eliminated. This makes it possible to improve accuracy of learning of the full-close reference position of the throttle valve while suppressing deterioration in startability and mechanical durability and power consumption.

### BRIEF DESCRIPTION OF THE DRAWINGS

In the accompanying drawings:

FIG. 1 is a diagram schematically showing the structure of a control device for an internal combustion engine according to a first embodiment of the present invention;

FIG. 2 is a flowchart showing operations concerning position learning processing by an ECU of FIG. 1;

FIG. 3 is a flowchart showing operations concerning learning permission judgment processing by the ECU of FIG. 1;

FIG. 4 is a diagram for explaining operation timing of position learning processing for a throttle valve; and

FIG. 5 is a flowchart showing operations of a control device for an internal combustion engine according to a second embodiment of the present invention.

### DETAILED DESCRIPTION OF THE PREFERRED EMBODIMENTS

In the following, preferred embodiments of the present invention are described with reference to the drawings.

### First Embodiment

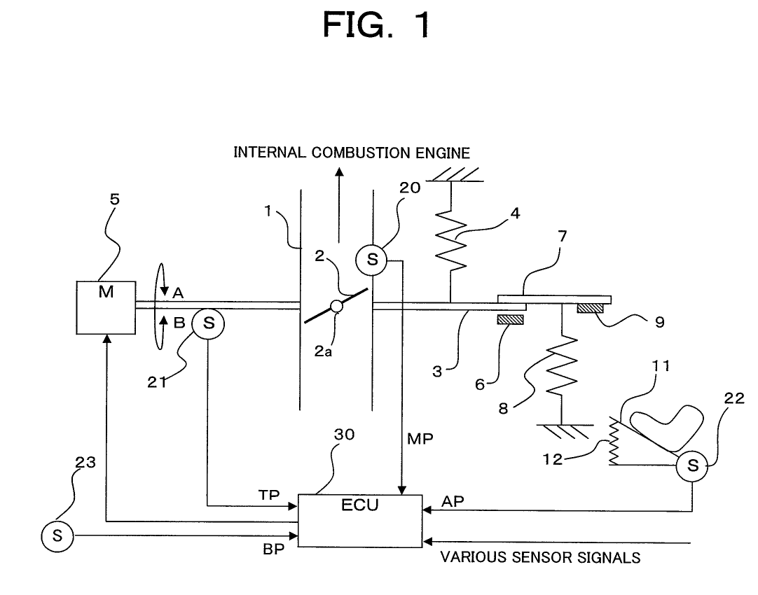

FIG. 1 is a diagram schematically showing the structure of a control device for an internal combustion engine according to a first embodiment of the present invention.

In FIG. 1, an intake pipe 1 forms an intake passage as an air passage that leads air from an air intake port (not shown) side of a vehicle to an internal combustion engine (not shown) side. A pressure sensor (vacuum sensor) 20 and a throttle valve 2 are provided in the inside of the intake pipe 1. The air pressure in the intake passage of the intake pipe 1 is converted into an electric signal as an intake passage pressure MP by the pressure sensor 20.

The throttle valve 2 is pivotable about a rotating shaft 2a. The throttle valve 2 is pivoted to be displaceable between a full-close position (maximum close position) and a full-open position (maximum open position). Therefore, the intake passage of the intake pipe 1 is opened and closed by the throttle valve 2. The rotating shaft 2a is coupled to a valve driving shaft 3.

The rotating shaft 2a and the throttle valve 2 are pivoted together with the valve driving shaft 3. Specifically, when the valve driving shaft 3 is pivoted in one direction (indicated by an arrow A of FIG. 1) of a circumferential direction thereof, the throttle valve 2 is pivoted in an opening direction. On the other hand, when the valve driving shaft 3 is pivoted in the other direction (indicated by an arrow B of FIG. 1) of the circumferential direction of thereof, the throttle valve 2 is pivoted in a closing direction.

A spring for evacuation traveling 4 is connected to the valve driving shaft 3 through a first lever (not shown). The valve driving shaft 3 is pulled by the spring for evacuation traveling 4 to pivot in one direction (indicated by the arrow A) of the circumferential direction of the valve driving shaft 3. A second lever (not shown) is provided at one end (right end in the figure) of the valve driving shaft 3.

The other end (left end in the figure) of the valve driving shaft 3 is connected to a motor 5 serving as an actuator. The valve driving shaft 3 is pivoted (or rotated) by driving force of the motor 5. In other words, the throttle valve 2 is pivoted by the driving force of the motor 5. A throttle opening sensor 21 is attached to the valve driving shaft 3. A pivoting amount of the valve driving shaft 3 is converted into an electric signal (voltage value) as throttle opening TP detected by the throttle opening sensor 21.

A full-close stopper 6, a full-open stopper (not shown), and an intermediate position maintaining shaft 7 are provided in a place adjacent to one end of the valve driving shaft 3. When the valve driving shaft 3 is pivoted in one direction of the circumferential direction thereof, the second lever comes into contact with the full-open stopper. When the second lever comes into contact with the full-open stopper, the pivoting in one direction of the circumferential direction of the valve driving shaft 3 is regulated. When the second lever is in contact with the full-open stopper, the throttle valve 2 is arranged in the full-open position.

Similarly, when the valve driving shaft 3 is pivoted in the other direction of the circumferential direction thereof, the second lever comes into contact with the full-close stopper 6. When the second lever comes into contact with the full-close stopper 6, the pivoting in the other direction of the circumferential direction of the valve driving shaft 3 is regulated. When the second lever is in contact with the full-close stopper 6, the throttle valve 2 is arranged in the full-close position. In other words, the full-close stopper 6 defines a limit in an operation range in the closing direction of the throttle valve 2.

The intermediate position maintaining shaft 7 is arranged along an axial direction of the valve driving shaft 3 to extend to an outer side in the axial direction of the valve driving shaft 3. At one end (left end in the figure), in the middle, and at the other end (right end in the figure) of the intermediate position maintaining shaft 7, a third lever, a fourth lever, and a fifth lever (all of which are not shown in the figure) are provided, respectively. The third lever can come into contact with the second lever of the valve driving shaft 3. In other words, when the second lever and the third lever are brought into contact with each other, the valve driving shaft 3 and the intermediate position maintaining shaft 7 are connected to each other.

A valve return spring 8 is connected to the intermediate position maintaining shaft 7 through the fourth lever. The intermediate position maintaining shaft 7 is pulled by the valve return spring 8 to pivot in one direction (same direction as the direction indicated by the arrow A in the figure) of a circumferential direction of the intermediate position maintaining shaft 7. An intermediate stopper 9 is provided in a place adjacent to the other end of the intermediate position maintaining shaft 7.

The intermediate position maintaining shaft 7 is pulled by the valve return spring 8, and hence the fifth lever comes into contact with the intermediate stopper 9. When the fifth lever comes into contact with the intermediate stopper 9, the pivoting in one direction of the circumferential direction of the intermediate position maintaining shaft 7 is regulated.

Tensile force of the valve return spring 8 is set larger than tensile force of the spring for evacuation traveling 4. Consequently, when electric power is not supplied to the motor 5, the second lever and the third lever are brought into contact with each other by the tensile force of the spring for evacuation traveling 4. In other words, the valve driving shaft 3 and the intermediate position maintaining shaft 7 are connected to each other.

At the same time, the intermediate position maintaining shaft 7 is brought into contact with the intermediate stopper 9 by the tensile force of the valve return spring 8. Consequently, the pivoting in one direction (indicated by the arrow A in the figure) of the circumferential direction of the valve driving shaft 3 is regulated. In this state, the throttle valve 2 is arranged in an intermediate position between the full-close position and the full-open position.

On the other hand, when electric power is supplied to the motor 5 and the motor 5 normally rotates (or reversely rotates), driving force in one direction of the circumferential direction of the valve driving shaft 3 is applied to the valve return spring 8. When the driving force exceeds the tensile force of the valve return spring 8, the regulation of the pivoting of the valve driving shaft 3 by the intermediate position maintaining shaft 7 and the intermediate stopper 9 is released. As a result, the valve driving shaft 3 is pivoted in one direction of the circumferential direction thereof and the throttle valve 2 is pivoted in the opening direction. When the throttle valve 2 is pivoted in the opening direction, the throttle opening TP increases.

When electric power is supplied to the motor 5 and the motor 5 reversely rotates (or normally rotates), driving force in the other direction of the circumferential direction of the valve driving shaft 3 is applied to the valve return spring 8. When the driving force exceeds the tensile force of the spring for evaluation traveling 4, the valve driving shaft 3 is pivoted in the other direction of the circumferential direction thereof. As a result, according to the pivoting in the other direction of the circumferential direction of the valve driving shaft 3, the throttle valve 2 is pivoted in the closing direction. When the throttle valve 2 is pivoted in the closing direction, the throttle opening TP decreases.

An accelerator return spring 12 is connected to an accelerator pedal 11 in a cabin of the vehicle. The accelerator pedal 11 is urged in a returning direction of the accelerator pedal 11 (clockwise direction in the figure) by the accelerator return spring 12. Therefore, in a state where the accelerator pedal 11 is not operated (accelerator OFF state), the accelerator pedal 11 is brought into contact with an accelerator full-close stopper (not shown) by urging force of the accelerator return spring 12. The accelerator pedal 11 is regulated from pivoting in the returning direction by being brought into contact with the accelerator full-close stopper.

An accelerator opening sensor 22 is provided in the accelerator pedal 11. An operation amount (step-in amount) of the accelerator pedal 11 by a driver is converted into an electric signal as an accelerator opening AP by the accelerator opening sensor 22. An atmospheric pressure sensor 23 is also provided in the vehicle. The atmospheric pressure is converted into an electric signal as the atmospheric pressure BP by the atmospheric pressure sensor 23.

Electric signals generated by sensors, i.e., the pressure sensor 20, the throttle opening sensor 21, the accelerator opening sensor 22, the atmospheric pressure sensor 23, and other sensors (e.g., a cooling water temperature sensor and a rotating speed sensor) are sent to an electronic control unit (ECU) 30 serving as a throttle-valve control unit.

The ECU 30 controls the operation of the internal combustion engine including the driving of the motor 5 and fuel injection timing. The ECU 30 monitors, on the basis of the electric signals from the respective sensors, for example, physical amounts necessary for the operation of the internal combustion engine such as intake passage pressure, throttle opening, accelerator opening, atmospheric pressure, cooling water temperature, and rotating speed. In addition, the ECU 30 monitors ON and OFF states of an ignition switch (not shown).

Moreover, the ECU 30 supplies electric power (sends a driving signal) to the motor 5 according to the operation amount of the accelerator pedal 11 during the normal operation of the internal combustion engine. The ECU 30 displaces a position of the throttle valve 2 by normally rotating or reversely rotating the motor 5. In other words, the ECU 30 controls opening and closing of the throttle valve 2 by controlling the driving of the motor 5. The throttle opening TP is fed back to the ECU 30 via the throttle opening sensor 21.

The ECU 30 performs position learning processing and learning permission judgment processing (learning start judgment processing) as a part of the opening and closing control for the throttle valve 2. The position learning processing is processing for learning (storing) a full-open position and a full-close position of the throttle valve 2 as a full-open reference position and a full-close reference position, respectively. The learning permission judgment processing is processing for judging whether the position learning processing should be executed. The learning permission judgment processing is processing (subroutine) executed by the ECU 30 in one process of the position learning processing.

Specifically, the ECU 30 judges, in the learning permission judgment processing, whether all of a first learning permission condition, a second learning permission condition (normal learning permission condition), and a third learning permission condition as a learning start condition are satisfied. The first learning permission condition is a condition judged by the ECU 30 as being satisfied when the ignition switch is in the OFF state, i.e., the internal combustion engine is in an engine stop state.

The second learning permission condition is a condition judged by the ECU 30 as being satisfied on the basis of, for example, a temperature difference in cooling water temperature based on that in the previous learning or elapsed time from the previous learning. The third learning permission condition is a condition judged by the ECU 30 as being satisfied because the intake passage pressure MP exceeds a predetermined value (fixed value, or predetermined learning start reference value) kMP registered in the ECU 30 in advance. The predetermined value kMP is a value between vacuum pressure and the atmospheric pressure and is set to a value for excluding an error due to negative pressure from the throttle opening TP detected by the throttle opening sensor 21.

The ECU 30 has an arithmetic processing unit (CPU), storing units (ROM, RAM, and the like), an input/output circuit, and a bus line (all of which are not shown in the figure). The storing units of the ECU 30 store programs for executing the respective kinds of processing, i.e., the position learning processing (by valve position learning means) and the learning permission judgment processing (by learning permission judging means and learning prohibiting means).

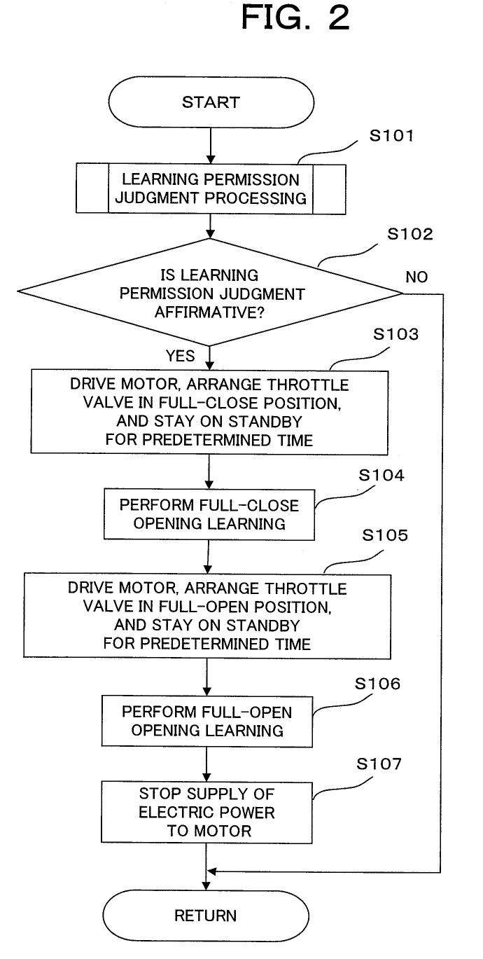

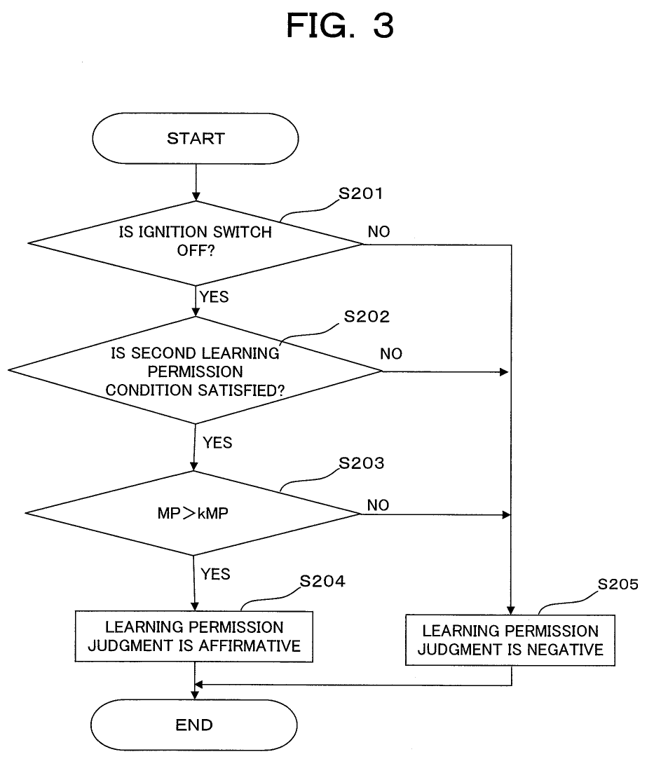

Next, operations are described. FIG. 2 is a flowchart showing operations concerning the position learning processing by the ECU 30 of FIG. 1. FIG. 3 is a flowchart showing operations concerning the learning permission judgment processing by the ECU 30 of FIG. 1. The operations shown in FIGS. 2 and 3 are repeatedly performed by the ECU 30 as a part of operation control for the internal combustion engine. In FIG. 2, first, the ECU 30 executes the learning permission judgment processing (Step S101).

In FIG. 3, after executing the learning permission judgment processing, the ECU 30 confirms whether the ignition switch is in the OFF state, i.e., the first learning permission condition is satisfied (Step S201). When it is confirmed that the ignition switch is in the OFF state (YES in Step S201), the ECU 30 confirms whether the second learning permission condition is satisfied (Step S202).

When it is confirmed that the second learning permission condition is satisfied (YES in Step S202), the ECU 30 confirms whether the intake passage pressure MP is larger than the predetermined value kMP, i.e., the third learning permission condition is satisfied (Step S203). When it is confirmed that the intake passage pressure MP exceeds the predetermined value kMP (YES in Step S203), the ECU 30 judges that all of the first to third learning permission conditions are satisfied and sets a learning permission judgment flag to “1 (permitted)” (Step S204). Consequently, the learning permission judgment processing by the ECU 30 is finished.

On the other hand, when it is confirmed that the ignition switch is in the ON state (NO in Step S201), when it is confirmed that the second learning permission condition is not satisfied (NO in Step S202), or when it is confirmed that the intake passage pressure MP is equal to or lower than the predetermined value kMP (NO in Step S203), the ECU 30 judges that one of the first to third learning permission conditions is not satisfied and sets the learning permission judgment flag to “0 (not permitted)” (Step S205). Consequently, the learning permission judgment processing by the ECU 30 is finished.

Referring back to FIG. 2, the ECU 30 confirms whether the learning permission judgment processing is affirmative (Step S102). When it is confirmed that the learning permission judgment is negative (NO in Step S102), i.e., the learning permission judgment flag is “0”, the ECU 30 repeatedly executes the learning permission judgment processing and stays on standby until the learning permission judgment becomes affirmative.

On the other hand, when it is confirmed that the learning permission judgment is affirmative (YES in Step S102), i.e., the learning permission judgment flag is “1”, the ECU 30 drives the motor 5, arranges the throttle valve 2 in the full-close position, and stays on standby for a predetermined time (e.g., one second) while keeping the state of the throttle valve 2 (Step S103). The ECU 30 stores the throttle opening TP from the throttle opening sensor 21 as a full-close reference position. In other words, the ECU 30 performs full-close opening learning (Step S104).

After that, the ECU 30 drives the motor 5, arranges the throttle valve 2 in the full-open position, and stays on standby for a predetermined time (e.g., 0.5 second) while keeping the state of the throttle valve 2 (Step S105). When the predetermined time elapses, the ECU 30 stores the throttle opening TP from the throttle opening sensor 21 as a full-open reference position. In other words, the ECU 30 performs full-open opening learning (Step S106). The ECU 30 stops the supply of electric power to the motor 5 (Step S107) and repeats the same operations.

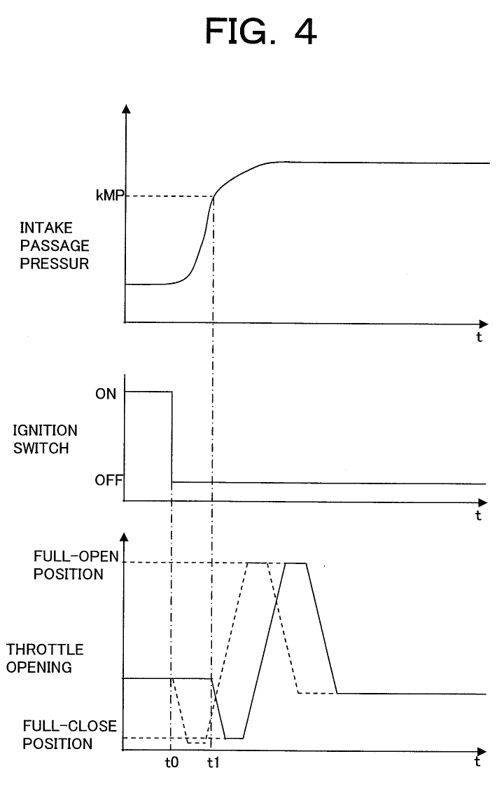

FIG. 4 is an explanatory diagram for explaining operation timing of the position learning processing for the throttle valve 2. FIG. 4 shows, when the ignition switch is switched from the ON state to the OFF state, a relation between the transition of the intake passage pressure MP during the change of the internal combustion engine from the idling state to the engine stop state and the throttle opening TP in the throttle position learning. Further, in FIG. 4, when the ignition switch is switched from the ON state to the OFF state, the throttle opening TP at the start of the throttle position learning processing is indicated by a broken line. In addition, in FIG. 4, when the intake passage pressure MP exceeds the predetermined value kMP, the throttle opening TP at the start of the throttle position learning processing is indicated by a solid line.

As an example of an output characteristic, the throttle opening sensor 21 outputs 4.5 V as the throttle opening TP when the throttle valve 2 is arranged in the full-open position and outputs 0.3 V as the throttle opening TP when the throttle valve 2 is arranged in the full-close position. Under such a condition, when the ignition switch is switched from the ON state to the OFF state (t0 in the figure), the ECU 30 executes the position learning processing. When the throttle valve 2 is arranged in the full-close position, the throttle opening sensor 21 outputs 0.2 V as the throttle opening TP. In other words, the throttle valve 2 is pressed in the closing direction by negative pressure, and hence an output voltage of the throttle opening sensor 21 decreases by 0.1 V.

On the other hand, after the ignition switch is switched from the ON state to the OFF state, when the intake passage pressure MP exceeds the predetermined value kMP (t1 in the figure), the ECU 30 executes the position learning processing. When the throttle valve 2 is arranged in the full-close position, the throttle opening sensor 21 outputs 0.3 V as the throttle opening TP. In other words, the throttle opening sensor 21 outputs a voltage value identical with that output when no negative pressure is generated.

As described above, with the control device for the internal combustion engine according to the first embodiment, the ECU 30 judges, on the basis of a mutual relation between the predetermined value kMP and the intake passage pressure MP, whether the third learning permission condition is satisfied. When it is judged that the third learning permission condition is satisfied, the ECU 30 performs learning of a full-close reference position of the throttle valve 2. This makes it possible to perform position learning for the throttle valve 2 in a state where pressing force against the throttle valve 2 due to negative pressure is reduced or eliminated. In addition, it is possible to suppress fluctuation from occurring in learning values of a full-closed reference position by the ECU 30 and, for example, always perform stable flow rate control even in the idling state.

Unlike the internal combustion engine disclosed in JP 2000-120450 A, the position learning for the throttle valve 2 is not performed with a start period of cranking as a reference. Therefore, it is possible to suppress the deterioration in startability of the internal combustion engine.

Moreover, the excessive operation of the motor disclosed in JP 11-159352 A is unnecessary. Therefore, it is possible to suppress the deterioration in mechanical durability and power consumption. Therefore, the control device for the internal combustion engine according to the first embodiment can improve accuracy of learning of the full-close reference position of the throttle valve 2 while suppressing the deterioration in startability and mechanical durability and power consumption.

In the first embodiment, when the intake passage pressure MP exceeds the predetermined value kMP, the ECU 30 judges that the third learning permission condition is satisfied. However, the present invention is not limited to this example. The ECU 30 only has to be capable of preventing erroneous learning of the full-close reference position of the throttle valve 2 on the basis of the mutual relation between the learning start reference value and the intake passage pressure. For example, when the intake passage pressure in the engine stop state exceeds a value set in advance as the learning start reference value, i.e., a deviation from the intake passage pressure MP in the idling state, the ECU 30 may judge that the third learning permission condition is satisfied.

### Second Embodiment

In the first embodiment, when the intake passage pressure MP exceeds the predetermined value kMP, the ECU 30 judges that the third learning permission condition is satisfied. On the other hand, in a second embodiment of the present invention, when a deviation of the intake passage pressure MP from the atmospheric pressure BP is smaller than a predetermined value (fixed value, or learning start reference value) kBMP set in advance in the ECU 30, the ECU 30 judges that the third learning permission condition is satisfied. In other words, in the second embodiment, the ECU 30 judges, on the basis of a mutual relation between the atmospheric pressure BP and the predetermined value kBMP in addition to the intake passage pressure MP, that the third learning permission condition is satisfied.

Like the predetermined value kMP in the first embodiment, the predetermined value kBMP in the second embodiment is a value for excluding an error due to negative pressure from the throttle opening TP detected by the throttle opening sensor 21. For example, the predetermined value kBMP is 200 mmHg. In other words, when the deviation of the intake passage pressure MP from the atmospheric pressure BP becomes smaller than, for example, 200 mmHg, the ECU 30 judges that the third learning permission condition is satisfied. Otherwise, the second embodiment is the same as the first embodiment.

Next, operations of the ECU 30 according to the second embodiment are described. The operations of the ECU 30 according to the second embodiment are different from those according to the first embodiment in the operation for judging whether the second learning permission condition is satisfied (Step S203 shown in FIG. 3). Only the difference from the first embodiment is described below.

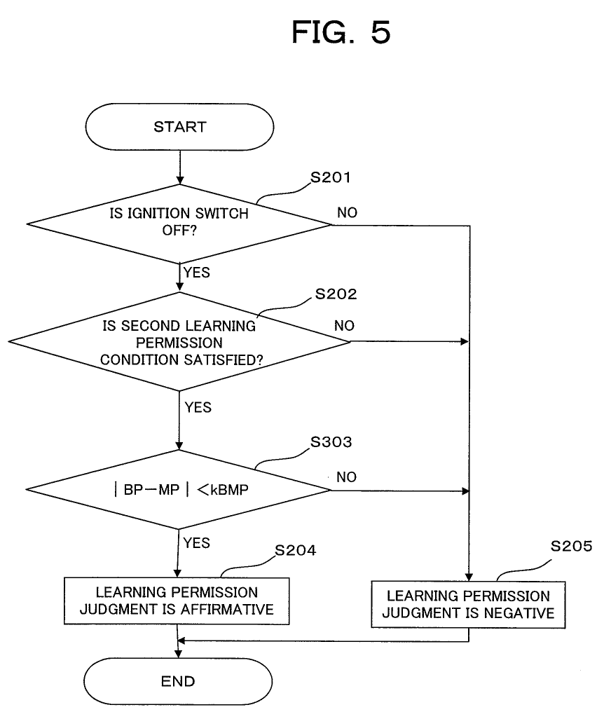

FIG. 5 is a flowchart showing the operations of the ECU 30 according to the second embodiment of the present invention. In FIG. 5, operations concerning the learning permission judgment processing by the ECU 30 are shown. In FIG. 5, when it is confirmed that the second learning permission condition is satisfied (YES in Step S202), the ECU 30 confirms whether |BP-MP| is smaller than |kBMP|, i.e., whether the third learning permission condition is satisfied (Step S303). When it is confirmed that the deviation of the intake passage pressure MP from the atmospheric pressure BP is equal to or larger than the predetermined value kBMP (YES in Step S303), the ECU 30 judges that all of the first to third learning permission conditions are satisfied and sets the learning permission judgment flag to “1 (permitted)” (Step S204). Consequently, the learning permission judgment processing by the ECU 30 is finished.

On the other hand, when it is confirmed that the deviation of the intake passage pressure MP from the atmospheric pressure BP is smaller than the predetermined value kBMP (NO in Step S303), the ECU 30 judges that the third learning permission condition is not satisfied and sets the learning permission judgment flag to “0 (not permitted)” (Step S205). Consequently, the learning permission judgment processing by the ECU 30 is finished. Otherwise, the operations concerning the learning permission judgment processing are the same as those in the first embodiment.

The atmospheric pressure fluctuates according to the altitude, meteorological conditions, and the like. The pressing force against the throttle valve 2 due to negative pressure fluctuates according to the atmospheric pressure. In other words, when the throttle valve 2 is affected by the fluctuation in the atmospheric pressure, erroneous learning may also occur.

On the other hand, in the control device for the internal combustion engine according to the second embodiment, when the deviation of the intake passage pressure MP from the atmospheric pressure BP becomes smaller than the predetermined value kBMP, the ECU 30 judges that the third learning permission condition is satisfied. This makes it possible to perform the position learning for the throttle valve 2 in a state where the influence of the fluctuation in the atmospheric pressure on the throttle valve 2 is reduced or eliminated. Therefore, it is possible to further improve accuracy of the position learning for the throttle valve 2.

In the second embodiment, when the deviation of the intake passage pressure MP from the atmospheric pressure BP is smaller than the predetermined value kBMP, the ECU 30 judges that the third learning permission condition is satisfied. However, the present invention is not limited to this example. The ECU 30 only has to be capable of preventing erroneous learning of the full-close reference position of the throttle valve 2 on the basis of a mutual relation between the intake passage pressure MP/the atmospheric pressure BP and the learning start reference value taking into account the influence of the fluctuation in the atmospheric pressure on the throttle valve 2.

In the first and second embodiments, the ECU 30 monitors the atmospheric pressure BP via the atmospheric pressure sensor 23. However, the present invention is not limited to this example. The atmospheric pressure sensor 23 does not have to be provided if it is possible to accurately acquire the atmospheric pressure by, for example, measuring the intake passage pressure MP and estimating the atmospheric pressure when the engine is stopped immediately after the ignition switch is switched from the OFF state to the ON state.

In the first and second embodiments, in the learning permission judgment processing, the ECU 30 executes the position learning processing when all of the first learning permission condition, the second learning permission condition, and the third learning permission condition are satisfied. However, the present invention is not limited to this example. The ECU 30 may execute the position learning processing when only the first learning permission condition and the third learning permission condition are satisfied.

In the first and second embodiments, the ECU 30 displaces the throttle valve 2 to the full-close position by driving the motor 5 in the position learning processing. However, the present invention is not limited to this example. For example, a clutch may be provided between the throttle valve 2 and the motor 5 in the valve driving shaft 3 and a spring may be provided to cause the valve driving shaft 3 to pivot in the closing direction of the throttle valve 2 when the clutch is opened. When the clutch and the spring are provided, it is possible to displace the throttle valve 2 to the full-close position by opening the clutch and blocking (disconnecting) a path for transmitting driving force from the motor 5 to the throttle valve 2.

What is claimed is:

1. A control device for an internal combustion engine, comprising a throttle-valve control unit that monitors throttle opening of a throttle valve which opens and closes an intake passage, accelerator opening, and intake passage pressure, controls opening and closing of the throttle valve according to the accelerator opening by driving an actuator connected to the throttle valve, drives, when it is judged that a predetermined learning start condition is satisfied, the actuator to arrange the throttle valve at a limit in an operation range in a closing direction, and learns a full-close position of the throttle valve as a full-close reference position on the basis of the throttle opening of the throttle valve at the limit, wherein
the throttle-valve control unit judges, during engine stop, whether the learning start condition is satisfied on the basis of a mutual relation between a predetermined learning start reference value and the intake passage pressure.

2. A control device for an internal combustion engine according to claim 1, wherein the throttle-valve control unit judges, when the intake passage pressure exceeds a fixed value set in advance as the learning start reference value between vacuum pressure and atmospheric pressure, that the learning start condition is satisfied.

3. A control device for an internal combustion engine according to claim 1, wherein the throttle-valve control unit judges, when the intake passage pressure exceeds a value set in advance as the learning start reference value, i.e., a deviation from the intake passage pressure in an idling state, that the learning start condition is satisfied.

4. A control device for an internal combustion engine according to claim 1, wherein the throttle-valve control unit further monitors atmospheric pressure and judges, when a deviation of the intake passage pressure from the atmospheric pressure becomes smaller than a fixed value set in advance as the learning start reference value, that the learning start condition is satisfied.
